(19) United States
(12) Patent Application Publication
(10) Pub. No.: US 2013/0317986 A1
(43) Pub. Date: Nov. 28, 2013

(54) DIGITAL SAFE DEPOSIT BOXES

(71) Applicant: Jeff Tucker, Stallings, NC (US)

(72) Inventor: Jeff Tucker, Stallings, NC (US)

(73) Assignee: BANK OF AMERICA CORPORATION, Charlotte, NC (US)

(21) Appl. No.: 13/480,152

(22) Filed: May 24, 2012

(51) Int. Cl. G07F 19/00; G06Q 40/02; E05G 1/02

(52) U.S. Cl. 705/43; 109/23; 705/42

(57) ABSTRACT

Systems, methods, and computer program products are provided for a digital safe deposit box. The digital safe deposit box provides for a user to configure safe deposit box categories for receiving uploads and storing safe deposit box items, such as essential documents, image files, video files or the like. The digital safe deposit box, may be accessible by third parties by providing third parties a secondary login and, more specifically only designated items or categories within the safe deposit box may be accessible or visible to the third party based on user pre-configuration of visibility settings.

### FIELD

In general, embodiments herein disclosed relate to computing networks and, more specifically, systems, methods, and computer program products for a secure digital safe deposit box.

### BACKGROUND

Traditionally, financial institution customers have implemented safe deposit boxes as a means of storing important documents such as wills, property deeds, passports and the like. However, safe deposit boxes tend to be small in size and, therefore, limited in the amount items and, in particular, documents that may be stored therein. As such, individuals or other entities, such as small businesses, typically resort to keeping extensive files of important documents at their residence or place of business. These “at-home” files may include, but are not limited to, real estate related documentation, automobile titles, home appliance warranties, life/automobile insurance documents, retirement account documentation, passports, birth certificates, immigration documentation, diplomas, transcripts, medical records and the like. In addition, residential files may store a myriad of tax-related record data, such as credit card statements, utility receipts, automobile mileage/fuel receipts, travel receipts and the like. It becomes quite apparent that these “at-home” files can and do become quite large and require an ample amount of allocated physical space and filing cabinets to accommodate the files. It should also be apparent that residential-based files are generally not secure files and, therefore, are susceptible to theft, fire, flood, tampering or other actions.

In addition to the storage capacity and security issues related to residential storage of important documentation, the mere volume of paper involved poses many personal and societal problems. From the personal perspective, as individual's lives become more complicated and involved keeping track of important documents becomes a daunting task. In this regard, individuals are required to allocate a significant portion of their time to keep track of important documentation and insure that it is properly filed. Due to the very nature of a paper-based system, regardless of how many safeguards are implemented by the individual, documentation can get misplaced or otherwise lost before it ever makes its way to the safe deposit box and/or residential files, thereby, exasperating the issue related to time-consumption.

From the societal perspective, the volume of paper that is created is counter-intuitive to the need to make our everyday lives more “green” and reduce negative impact on the environment. While the move is afoot to a so-called “paperless-society”, the current reality is that individuals are coping with more and more important documentation that needs to be tracked and filed as their lives become more involved and their time more valuable.

Therefore, a need exists to create a system for important documentation storage. The desired system should be all-encompassing, such that an individual can track and store all of their important documentation in one comprehensive system. In addition, the desired system should offer a level of security beyond residential-based storage of documentation, in that, the desired system should protect against physical damage due to fire flood or the like and nefarious actions, such as theft, tampering or the like. Additionally, the desired system should provide on-demand access to important documentation and add efficiency to the process of tracking and storing important documentation, thereby making individuals' lives more manageable. Also, from a societal perspective the desired system should significantly decrease the volume of paper that an individual typically requires for tracking and storing important documentation.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, systems and computer program products are defined that provide for a digital safe deposit box. The digital safe deposit box may, in some embodiments, be provided for by a financial institution and as such, the user of the safe deposit box may be an individual customer of the financial institution, or a small business/commercial entity that is also a customer of the financial institution. In such embodiments in which the digital safe deposit box provider is a financial institution, network access to the safe deposit box may be provided in conjunction with online banking or some other public networked site.

In accordance with embodiments herein disclosed, the digital safe deposit box provides for user-configured digital safe deposit box categories, such that the digital safe deposit box is associated with a user's online banking account. Further, the digital safe deposit box may be accessed via an online banking portal. As such, the user may be provided a primary login associated with the online banking portal such that the primary login may be entered prior to accessing the digital safe deposit box to authenticate the user's credentials.

The digital safe deposit box of the present invention may receive a request from the user to grant a third party access to the digital safe deposit box. In one embodiment, one or more third parties may be granted access to the digital safe deposit box. As such, the third party may be provided one or more secondary logins. To this extent, the digital safe deposit box may be accessed by the third party via the secondary login portal. As such the secondary login may be entered, by the third party, prior to accessing the digital safe deposit box to authenticate the third parties credentials.

The digital safe deposit box of the present invention may receive uploads of a plurality of safe deposit box items. In one embodiment the digital safe deposit box may receive uploads of a plurality of safe deposit box items having a duplicate filename of an existing safe deposit box item such that the plurality of safe deposit box items having a duplicate filename of the existing safe deposit box item are uploaded as new versions of the existing safe deposit box item.

In another embodiment, the digital safe deposit box may provide a facsimile gateway such that a plurality of safe deposit items may be uploaded via facsimile. Furthermore, the digital safe deposit box may create an encoded facsimile coversheet such that the user is able to print the encoded coversheet via the online banking portal. The encoded facsimile coversheet may be submitted with the plurality of safe deposit items being uploaded via facsimile. In one embodiment, a general encoded facsimile coversheet may be created such that the general encoded facsimile coversheet specifies a new safe deposit box item is being uploaded. In an alternative embodiment, a document-specific encoded facsimile coversheet may be created such that the document specific facsimile coversheet specifies a new version of an existing safe deposit box item is being uploaded. In one embodiment the digital safe deposit box may distributing the encoded facsimile coversheet to a third party.

According to one embodiment of the invention, the digital safe deposit box may receive uploads via an authenticated kiosk such that the plurality of safe deposit box items are scanned at the authenticated kiosk. In one embodiment, the authenticated kiosk is located at a banking branch. In an alternative embodiment, the digital safe deposit box may receive uploads via an enhanced ATM. In one embodiment, the enhanced ATM may have scanning capabilities such that one or more safe deposit box items are scanned at the enhanced ATM.

According to an embodiment of the invention, upon receiving uploads of a plurality of digital safe deposit box items the digital safe deposit box may store the plurality of uploads. In one embodiment, the digital safe deposit box may store notes that provide comments for the digital safe deposit box. In one embodiment, the digital safe deposit box may store notes that reference an associated user-configured digital safe deposit box category. In another embodiment, the digital safe deposit box may store notes that reference of the plurality of digital safe deposit box items.

According to an embodiment of the invention, the user may configure visibility parameters for the digital safe deposit box. In one embodiment, visibility parameters may be configured to restrict the third parties access to view one or more safe deposit box items. In an alternative embodiment, the digital safe deposit box may have one or more user-configured safe such that visibility parameters may be configured for an associated user-configured digital safe deposit box category.

An apparatus provides for another embodiment of the invention. The apparatus includes a computer platform including at least one processor and a memory. The apparatus further includes a digital safe deposit box database stored in the memory. The database includes a plurality of user safe deposit boxes each having one or more user-configured safe deposit box categories. The apparatus also includes a digital safe deposit box module stored in the memory and executable by the processor. The digital safe deposit box module includes an external third party integration engine operable to receive a request from the user to grant a third party access to the digital safe deposit box. In one embodiment, the third party may be one or more third parties such that the digital safe deposit box provides the third party one or more secondary logins, based at least partially on the request, that are associated with a secondary login portal. As such, the digital safe deposit box is accessed by the third party via the secondary login portal. The digital safe deposit box module includes a safe deposit box item upload engine operable to receive uploads of safe deposit box items and store the safe deposit box items in a designated safe deposit box category of a designated user safe deposit box. In addition, the digital safe deposit box includes a visibility configuration engine operable to configure visibility parameters for the digital safe deposit box.

In further optional embodiments of the apparatus, the item upload engine may be further operable to receive uploads of a plurality of safe deposit box items having a duplicate filename of an existing safe deposit box item such that the plurality of safe deposit box items having a duplicate filename of an existing safe deposit box item are uploaded as new versions of the existing safe deposit box item.

In yet further optional embodiments of the apparatus, the item upload engine may be further operable to provide a facsimile gateway such that one or more safe deposit items are uploaded via facsimile. The apparatus may further comprise an encryption engine operable to create an encoded facsimile coversheet such that the user is able to print the encoded coversheet via the online banking portal. In one embodiment, the encoded facsimile coversheet may be submitted with the plurality of safe deposit items being uploaded via facsimile. In one embodiment, the encryption engine may be further operable to create a general encoded facsimile coversheet such that the general encoded facsimile coversheet specifies a new safe deposit box item is being uploaded. In an alternative embodiment, the encryption engine may be further operable to create a document-specific encoded facsimile coversheet such that the document specific facsimile coversheet specifies a new version of an existing safe deposit box item is being uploaded. The apparatus may further comprise an item distribution engine operable to distribute the encoded facsimile coversheet to the third party.

In further optional embodiments of the apparatus, the item upload engine may be further operable to receive uploads of the plurality of safe deposit box items via an authenticated kiosk such that the plurality of safe deposit box items are scanned at the authenticated kiosk. In one embodiment, the authenticated kiosk may be located at a banking branch. The item upload engine may be further operable to receive uploads of the plurality of safe deposit box items via an enhanced ATM. In one embodiment, the enhanced ATM has scanning capabilities such that one or more safe deposit box items are scanned at the enhanced ATM. The item upload engine may be further operable to store a plurality of notes such that the notes provide comments for one or more safe deposit box items.

According to further optional embodiments of the apparatus, the visibility configuration engine may be further operable to restrict the third parties access to view one or more safe deposit box items. As such, in one embodiment, the visibility configuration engine may configure visibility parameters for an associated user-configured digital safe deposit box category. In another embodiment, the visibility configuration engine may configure visibility parameters for each of the plurality of safe deposit box items.

A further embodiment of invention is defined by a computer program product that includes a computer-readable medium. The medium includes a first set of codes for causing a computer to provide for a digital safe deposit box that is associated with a user's online banking account such that the digital safe deposit box is accessed by the user via an online banking portal. The medium additionally includes a second set of codes for causing a computer to provide, for the user, a primary login that is associated with the online banking portal. The medium additionally includes a third set of codes for causing a computer to receive, from the user, a request to grant a third party access to the digital safe deposit box, where the third party may be one or more third parties. The medium additionally includes a fourth set of codes for causing a computer to provide, for the third party, one or more secondary logins, based at least partially on the request, that are associated with a secondary login portal such that the digital safe deposit box may be accessed by the third party via the secondary login portal. The medium additionally includes a fifth set of codes for causing a computer to receive uploads of a plurality of safe deposit box items. The medium additionally includes a sixth set of codes for causing a computer to store each of the plurality of safe deposit box. The medium additionally includes a seventh set of codes for causing a computer to configure visibility parameters for the digital safe deposit box.

In further optional embodiments of the invention, the fifth set of codes further comprises the fifth set of codes for causing a computer to receive uploads of a plurality of safe deposit box items having a duplicate filename of an existing safe deposit box item such that the plurality of safe deposit box items having a duplicate filename of an existing safe deposit box item are uploaded as new versions of the existing safe deposit box item. In another embodiment, the fifth set of codes further comprises the fifth set of codes for causing a computer to receive uploads of the plurality of safe deposit box items via an authenticated kiosk such that the plurality of safe deposit box items are scanned at the authenticated kiosk, wherein the authenticated kiosk is located at a banking branch. In another embodiment, wherein the fifth set of codes further comprises the fifth set of codes for causing a computer to receive uploads of the plurality of safe deposit box items via an enhanced ATM, wherein the enhanced ATM has scanning capabilities such that the plurality of safe deposit box items are scanned at the enhanced ATM. In one embodiment, the sixth set of codes further comprises the sixth set of codes for causing a computer to store a plurality of notes such that the notes provide comments for one or more safe deposit box items.

In further optional embodiments of the invention, the medium may additionally include an eighth set of codes for causing a computer to provide a facsimile gateway such that one or more of the safe deposit items are uploaded via facsimile. As such, the medium may additionally include a ninth set of codes for causing a computer to create an encoded facsimile coversheet such that the user is able to print the encoded coversheet via the online banking portal, where the encoded facsimile coversheet may be submitted with the plurality of safe deposit items being uploaded via facsimile. The medium may additionally include the ninth set of codes further comprises the ninth set of codes for causing a computer to create a general encoded facsimile coversheet such that the general encoded facsimile coversheet specifies a new safe deposit box item is being uploaded. The medium may additionally include the ninth set of codes further comprises the ninth set of codes for causing a computer to create a document-specific encoded facsimile coversheet such that the document specific facsimile coversheet specifies a new version of an existing safe deposit box item is being uploaded. As such, the medium may additionally include a tenth set of codes for causing a computer to distribute the encoded facsimile coversheet to the third party.

In further optional embodiments of the invention, the seventh set of codes further comprises the seventh set of codes for causing a computer to restrict the third parties access to view one or more safe deposit box items. The seventh set of codes may further comprise the seventh set of codes for causing a computer to configure visibility parameters for an associated user-configured digital safe deposit box category. Additionally, the seventh set of codes further comprises the seventh set of codes for causing a computer to configure for each of the plurality of safe deposit box items.

Thus, methods, systems, computer program products and the like are described in detail herein, which provide for a digital safe deposit box. The safe deposit box is all-encompassing, such that an individual can track and store all of their important documentation and other digital items in one comprehensive safe deposit box system. Ease of use is provided for by storing safe deposit box items in user-customizable categories and, in some embodiments, folders within the categories. The digital nature of the safe deposit box means that items stored therein are protected against physical damage due to fire, flood or the like and nefarious actions, such as theft, tampering or the like. Additionally, in those embodiments in which the safe deposit box is provided through a web-based platform, such as an online banking platform and mobile device access through an applicable mobile device platform the user is afforded on-demand and omnipresent access to the stored documentation and digital items.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram depiction of a system for digital safe deposit box storage, according to an embodiment of the present invention;

FIG. 2 is a block diagram depiction illustrating a digital safe deposit box receiving uploads from the safe deposit box provider, specifically a financial institution; in accordance with embodiments of the present invention;

FIG. 3 is a more detailed block diagram of an apparatus configured for providing a digital safe deposit box, in accordance with an embodiment of the present invention;

FIG. 4 is a block diagram highlighting the various optional engines included in a digital safe deposit box module, in accordance with present embodiments;

FIG. 5 is a block diagram illustrating exemplary safe deposit box categories, in accordance with present embodiments;

FIG. 6 is a flow diagram of a method for establishing a digital safe deposit box and storing uploading safe deposit box items in the safe deposit box, in accordance with present embodiments;

FIG. 7 is a flow diagram of a method for safe deposit box item renewal, in accordance with an embodiment of the present invention; and

FIG. 8 is a flow diagram of a method for digital safe deposit box storage, in accordance with yet another embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, methods, systems, computer programs and the like are herein disclosed that provide for a digital safe deposit box. The safe deposit box is all-encompassing, such that an individual can track and store all of their important documentation and other digital items in one comprehensive safe deposit box system. Ease of use is provided for by storing safe deposit box items in user-customizable categories and, in some embodiments, folders within the categories. The digital nature of the safe deposit box means that items stored therein are protected against physical damage due to fire, flood or the like and nefarious actions, such as theft, tampering or the like. Additionally, in those embodiments in which the safe deposit box is provided through a web-based platform, such as an online banking platform, and provides for mobile device access through an applicable mobile device platform, the user is afforded on-demand and omnipresent access to the stored documentation and digital items.

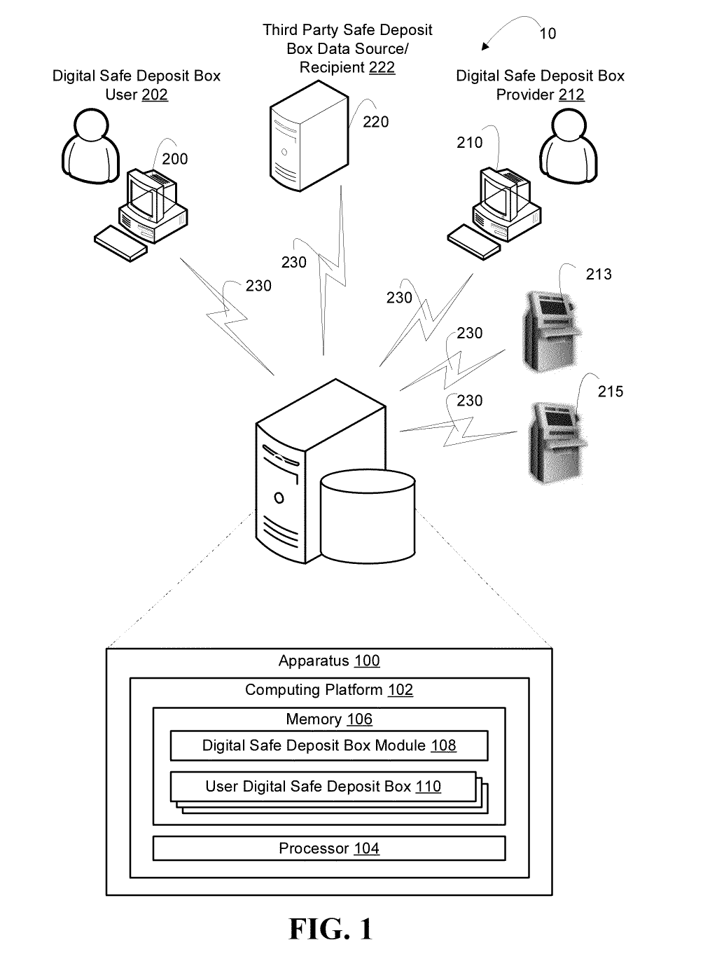

Referring to FIG. 1, a block diagram is depicted of a system 10 for digital safe deposit box storage, in accordance with an embodiment of the invention. The system includes an apparatus 100 that includes a computing platform 102 having at least one processor 104 and a memory 106. The memory 104 includes a plurality of user digital safe deposit boxes 110, such that each user digital safe deposit box 110 is operable to store digital safe deposit box items, such as documents, image file, video files, or the like. The memory also includes a digital safe deposit box module 108 that is operable to receive uploads of the safe deposit box items and store an upload in a corresponding user digital safe deposit box 110.

The system 10 also includes computer device 200 associated with digital safe deposit box user 202, computing device 210 associated with safe deposit box provider 212 and server 220 associated with third party safe deposit box data source/recipient 222. In accordance with present aspects, the digital safe deposit box module 108 of apparatus 100 may be operable to receive uploads of safe deposit box items from the safe deposit box user 202, the safe deposit box provider 212 and third party safe deposit box data source/recipient 222 via corresponding computing device 200, computing device 210 and server 220 through a network connection 230, which may be wired or wireless. By configuring the digital safe deposit box module such that it provides for uploading of safe deposit box items from multiple sources, including user 202, safe deposit box provider 212 and/or third party safe deposit box data source/recipient 222, the digital safe deposit box of the present invention can efficiently capture and store most, if not all, of the documentation that a user desires to store and access through digital safe deposit box 110.

The safe deposit box user 202, which may be an individual or a business entity, may manually upload safe deposit box items, such as documentation or the like, via computing device 200 or alternatively safe deposit box user 202 may configure computing device 200 to automatically upload safe deposit box items. In addition, while FIG. 1 depicts computing device 200 as being a personal computer (PC), the computing device may be any wired or wireless device capable of network communication. In one specific embodiment, the computing device 200 may be a handheld computing device, such as a cellular/mobile telephone, personal digital assistant (PDA), facsimile machine, scanner or the like, which provides for the user to dynamically upload safe deposit box items to the digital safe deposit box module 108 at any point in time, as well as, access safe deposit box items at any point in time. The digital safe deposit box user 202 may employ a variety of methods to upload safe deposit box items. Such methods include, but are not limited to, uploading via web browser, facsimile, scanning, emailing and the like.

The digital safe deposit box provider 212, which, according to certain embodiments, may be a financial institution, may manually upload safe deposit box items at the request of safe deposit box user 202 via computing device 210. For example, the safe deposit box service provider 212 may employ drop-boxes at various physical locales for safe deposit box users 202 to drop off hard-copy documents that the safe deposit box users desire to store in the digital safe deposit box 110. Subsequently, a safe deposit box provider representative may manually upload the hard-copy documents to the digital safe deposit box module 108. Use of drop-boxes by the digital safe deposit box provider 212 is especially beneficial if the safe deposit box user does not have the capability to upload safe deposit box items on their own or does not desire to be inconvenienced by uploading safe deposit box items.

Additionally, the digital safe deposit box provider 212 may provide for authenticated kiosks 213 at which digital safe deposit box user 202 may upload safe deposit box items. Such authenticated kiosks 213, which may be located at or near a financial institution/banking center, allow for the digital safe deposit box user 202 to scan or otherwise upload physical documents into the digital safe deposit box.

In additional embodiments of the invention, in which the digital safe deposit box provider 212 is a financial institution, the financial institution may provide enhanced Automated Teller Machines (ATMs) 215. In such embodiments, the enhanced ATM 215 is configured to allow the digital safe deposit box user 202 to scan or otherwise upload physical documents into the digital safety deposit box at the ATM.

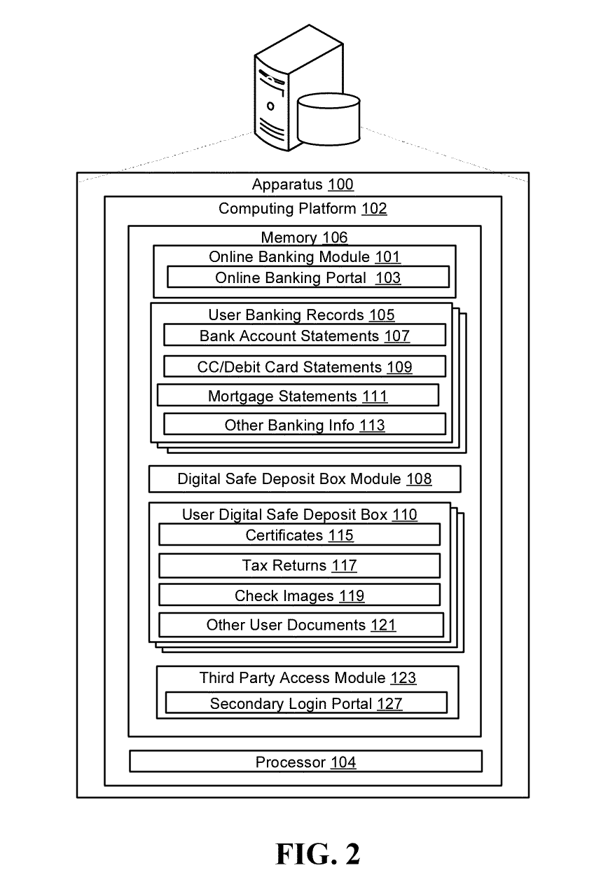

Alternatively, the safe deposit box provider 212 may, via computing device 210, automatically upload safe deposit box items to the digital safe deposit box module 108 on a periodic recurring or non-recurring basis based on safe deposit box user 202 configuration of their specific safe deposit box 110. For example, if the safe deposit box provider 212 is a financial institution, banking account statements, mortgage statements, credit card statements or the like may be automatically uploaded on a predetermined schedule, such as a monthly schedule or the like. FIG. 2, which will be discussed at length infra., provides a specific example of automatic safe deposit box item uploading as provided by a financial institution safe deposit box provider, in accordance with an embodiment of the present invention. It should be noted that while system 10 of FIG. 1 depicts apparatus 100 and computing device 210 as separate entities, according to embodiments herein disclosed, the operations and functions conducted by apparatus 100 and computing device 210 may be included in one single apparatus, such as apparatus 100. The reader is reminded of the assumption previously stated that an apparatus is not limited in form to a single device but rather may comprise multiple devices.

The third-party safe deposit box data source/recipient 222 may upload documents to the digital safe deposit box module 108 via server 220 based on a one-time request of safe deposit box user 202 or, alternatively, safe deposit box user 202 may configure the digital safe deposit box module 108 to automatically upload safe deposit box items from the third-party safe deposit box data source/recipient 222 at prescribed intervals or as safe deposit box items become available. Examples of third-party safe deposit box data sources may include, but are not limited to, income tax service providers; government agencies, such as automotive agencies and tax agencies; and commercial businesses, such as credit card companies, department stores or any other third-party that may have data suitable for safe deposit box storage. In the illustrated examples, the income tax service providers may upload income tax related documentation to the digital safe deposit box module 108, the automotive agency may upload automobile registration and/or inspection related documentation, the tax agency may upload income tax related documentation and the credit card companies and department stores may upload account statements.

In addition to receiving uploads of safe deposit box items from third party data source/recipients 222, digital safe deposit box module 108 may be configured to distribute/communicate safe deposit box items directly from the safe deposit box to a user-designated third party data source/recipient 222. In such embodiments, the safe deposit box user 202 may configure the digital safe deposit box module 108 to provide for a one-time-only distribution of one or more safe deposit box items or the safe deposit box user 202 may configure the digital safe deposit box module 108 to automatically distribute safe deposit box items on a recurring basis, either based on a predetermined schedule or as safe deposit box items become available in the user safe deposit box 110. In this regard, the third party data recipient may be an individual or a business entity. An example of a one-time-only safe deposit box distribution may be user-designated distribution of a real estate deed upon sale of the real estate parcel by the safe deposit box user to a third party. The safe deposit box distribution/communication of the deed may serve as a means of transferring the deed from the safe deposit box user to the third party.

Referring to the aforementioned FIG. 2, a block diagram is depicted of one aspect of the invention in which the safe deposit box provider is a financial institution. In such embodiments, the apparatus 100, which may include multiple devices, may include an online banking module 101 operable to provide an online banking portal 103 to banking customers for conducting banking transactions and the like. In such embodiments, the digital safe deposit box 110 may be accessible to the user/customer via the online banking portal 103. Since online banking portal 103 is accessible from any device having network connectivity, including handheld wireless devices, the digital safe deposit box 110 of the present invention may also be accessible from any device having network connectivity. As such, from the wireless handheld device perspective, the safe deposit box items stored in the digital safe deposit box 110 may be accessible anywhere at any point in time, such that the safe deposit box user may view and, in some instances receive, send or print, safe deposit box items on-demand, anytime, anywhere.

Additionally, the memory 106 of apparatus 100 may store user/customer banking records 105, which may be configured to be automatically uploaded to digital safe deposit box module 108 and stored in user/customer digital safe deposit box 110. User/customer banking records 105 may include, but are not limited to, bank account statements 107, credit card/debit card statements 109, mortgage statements 111 and any other banking/financial institution record information 113 that may be relevant to the user/customer. The user/customer may configure the digital safe deposit box 110 to upload any and all banking records on an automated and recurring basis, thereby eliminating the need for the financial institution to provide the user/customer with hard-copies of the banking records, typically delivered via postal service or the like. As such, the present invention may serve the further societal need of decreasing the user/customer's “carbon footprint” by decreasing the amount of paper that the user/customer consumes.

Additionally, the memory 106 of apparatus 100 may store digital safe deposit box 110. In addition to the aforementioned user banking records 105, digital safe deposit box 110 may store, but is not limited to storing, bank certificates 115, tax returns 117, check images 119, and any other miscellaneous documents 121 that may be relevant to the user/customer. The user/customer may configure the digital safe deposit box 110 to upload any and all digital safe deposit box items/documents on an automated and recurring basis, thereby eliminating the excessive paper trail associated with hard-copies of the user documents, typically delivered via postal service or the like. As such, the present invention may serve the further societal need of decreasing the user/customer's “carbon footprint” by decreasing the amount of paper that the user/customer consumes.

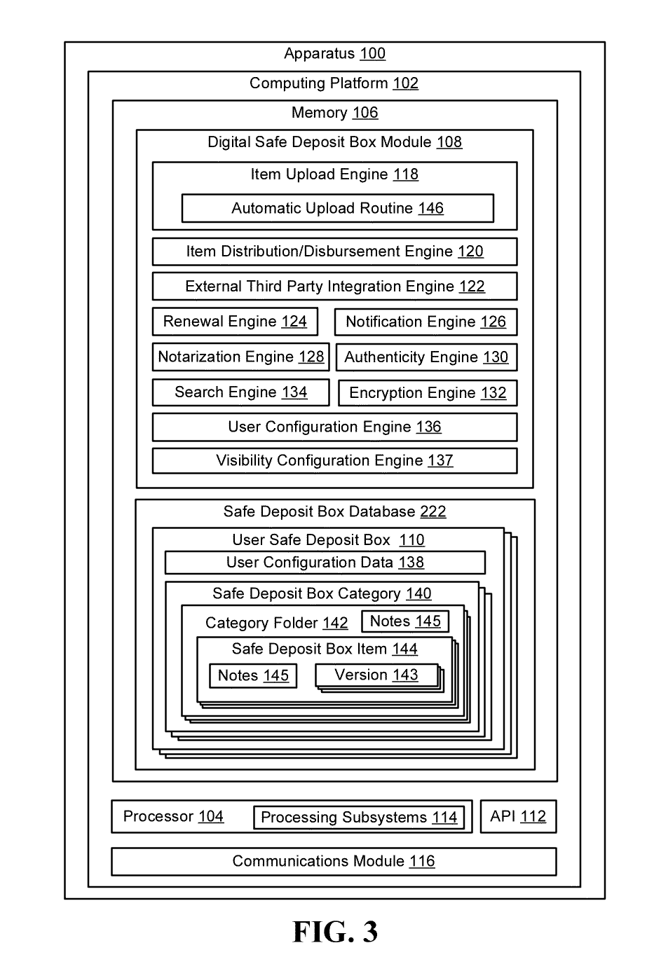

FIG. 3 provides a more detailed block diagram depiction of the apparatus 100, in accordance with an embodiment of the present invention. In addition to providing greater detail, FIG. 3 highlights various alternate embodiments of the invention. The apparatus 200 may include any type of one or more computerized, communication devices, such as a server, a personal computer, a portable computer, a facsimile machine, a scanner, a portable scanner or any device or devices that include a computer platform and have a wired and/or wireless connection to a network or the Internet.

The apparatus 100 includes computer platform 102 that can transmit data across a network, and that can receive and execute routines and applications. Computer platform 102 includes memory 106, which may comprise volatile and nonvolatile memory such as read-only and/or random-access memory (RAM and ROM), EPROM, EEPROM, flash cards, or any memory common to computer platforms. Further, memory 106 may include one or more flash memory cells, or may be any secondary or tertiary storage device, such as magnetic media, optical media, tape, or soft or hard disk.

Further, computer platform 102 also includes processor 104, which may be an application-specific integrated circuit (“ASIC”), or other chipset, processor, logic circuit, or other data processing device. Processor 104 or other processor such as ASIC may execute an application programming interface (“API”) layer 112 that interfaces with any resident programs, such as digital safe deposit box module 108 stored in the memory 106 of the apparatus 100.

Processor 104 includes various processing subsystems 114 embodied in hardware, firmware, software, and combinations thereof, that enable the functionality of apparatus 100 and the operability of the apparatus 100 on a network. For example, processing subsystems 114 allow for initiating and maintaining communications, and exchanging data, with other networked devices. For the disclosed embodiments, processing subsystems 114 of processor 104 may include any subsystem used in conjunction digital safe deposit box module 108.

Computer platform 102 additionally includes communications module 116 embodied in hardware, firmware, software, and combinations thereof, that enables communications among the various components of the apparatus 100, as well as between the apparatus 100 and an external network, such as the Internet or the like. In described embodiments, the communication module 116 enables the communication of all correspondence between apparatus 100 and other computing devices.

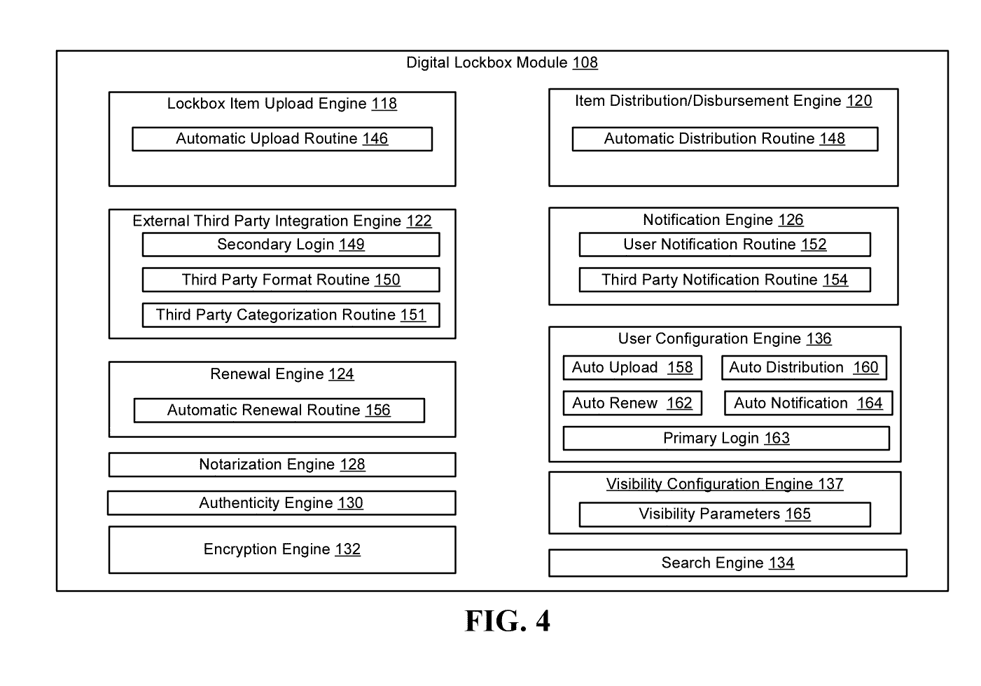

The memory 106 of computer platform 102 includes digital safe deposit box module 108 which is described in relation to FIG. 3 and FIG. 4. Digital safe deposit box module 108 includes digital item upload engine 118 operable to receive uploads of safe deposit box items 144 and store the safe deposit box items 144 in a corresponding user safe deposit box 110. According to one embodiment of the invention, digital item upload engine 118 may include automatic upload routine 146 that is operable to request automatic upload of user-specified items from third party safe deposit box date sources or from the safe deposit box provider, such as a financial institution, at predetermined intervals or as items become available. The safe deposit box user may configure requisite automatic upload routine 146 parameters such as the source of the safe deposit box items, the safe deposit box items to be uploaded, the interval for requesting the upload, the category/folder designated for the automatically uploaded safe deposit box item(s) and the like.

According to another embodiment, the item upload engine 118 may be operable to receive uploads of a plurality of safe deposit box items having a duplicate filename of an existing safe deposit box item. As such, the plurality of safe deposit items having a duplicate filename of the existing safe deposit box items may be uploaded as new versions 143 of the existing safe deposit box item. In one embodiment, the user may be given the option to replace the existing safe deposit box items with the safe deposit box item having a duplicate file name such that the existing safe deposit box item is no longer stored in the digital safe deposit box 110. In another embodiment, the user may be given the option to rename the safe deposit box item having a duplicate file name such that the safe deposit box item having a duplicate file name is not stored as a new version of the existing safe deposit box item. In addition, the item upload engine 118 may be operable to provide a facsimile gateway such that the plurality of safe deposit box items may be uploaded via facsimile.

In one embodiment, the item upload engine 118 may be operable to receive uploads of a plurality of safe deposit box items via an authenticated kiosk. As such, the plurality of safe deposit box items may be scanned into the digital safe deposit box at a banking branch using the authenticated kiosk. In another embodiment, the item upload engine 118 may be operable to receive uploads of a plurality of safe deposit box items via an enhanced ATM. As such, the plurality of safe deposit box items may be scanned into the digital safe deposit box using the enhanced ATM.

In addition, the item upload engine may be operable to store a plurality of notes 145 that provide comments for the digital safe deposit box items 144 in the digital safe deposit box. The notes may be authored by the digital safe deposit box user, the safe deposit box provider (e.g., financial institution), a third party safe deposit box data source or data recipient and/or some other individual or entity at the directive of the digital safe deposit box user. In one embodiment, the notes 145 may provide comments for one or more of the plurality of digital safe deposit box items. In another embodiment, the notes 145 may provide comments for one or more associated user-configured digital safe deposit box categories 140.

Additionally, digital safe deposit box module 108 may include safe deposit box item distribution/disbursement engine 120 that is operable for allowing the user to identify safe deposit box items that require communication to a third party and for initiating the communication of such identified safe deposit box items through communication module 116. According to one embodiment of the invention, a user may identify one or more safe deposit box items for one-time-only distribution to a designated third party. For example, the user may identify the user's passport or birth certificate for a one-time-only distribution to a new employer for the purpose of verifying identity and employment status. The user may also configure the means of the electronic distribution, such as email, facsimile transmission or the like. According to one embodiment of the invention, distribution/disbursement engine 120 may include an automatic distribution routine 148 that is operable to initiate automatic and recurring distribution of user-specified safe deposit box items for distribution to one or more third parties. For example, a user may designate that certain banking records, such as credit card statements or the like be distributed to a tax accountant. Since banking records are uploaded to the safe deposit box on a recurring basis at prescribed intervals, such as monthly or the like, the user may configure the automatic distribution routine 148 of the distribution/disbursement engine 120 to distribute the credit card statements to the tax account on a pre-configured interval, such as monthly, quarterly or the like. The item distribution/disbursement engine 120 may be operable to distribute an encoded facsimile coversheet to one or more designated parties such that a designated party may be a user of the digital safe deposit box 110 or a third party associated with the digital safe deposit box 110. The safe deposit box user may configure requisite automatic distribution routine 148 parameters such as the safe deposit box items to be distributed, the third parties to whom the items are to be distributed, the interval for distributing the safe deposit box items, the category/folder location of the safe deposit box items to be distributed and the like.

Additionally, digital safe deposit box module 108 may include third party integration engine 122 that provides for third party safe deposit box items to be seamlessly integrated into the user digital safe deposit box 110. As such, third party integration engine 122 may provide for a third party secondary login 149, a third party safe deposit box item format routine 150 operable to format received uploads of third party safe deposit box item into a format acceptable to the digital safe deposit box 110. In addition, the third party integration engine 122 may be operable to receive a request from the user to grant a third party access to the digital safe deposit box 110 as such one or more third parties may be granted access to the digital safe deposit box 110, based at least partially on the request. In one embodiment, the secondary login may grant the third party access to the user's safe deposit box via a secondary login portal. In one embodiment, the secondary login portal may be a separate entity from the online banking portal to prohibit the third party from accessing the user's online banking account or other data accessible at the online banking portal. In addition, the format routine 150 may provide for safe deposit box items that are to be designated for distribution to third parties to be formatted for distribution/transmission. In addition, third party integration engine 122 may include a third party safe deposit box item categorization routine 151 operable for identifying a best-match safe deposit box category 140 based on metadata or the like for subsequent storage in the identified safe deposit box category 140. In other optional embodiments, third party safe deposit box item categorization routine 151 may further be operable to identify a best-match safe deposit box folder within a safe deposit box category 140 based on metadata or the like for subsequent storage in the identified safe deposit box folder of a safe deposit box category 140.

In other embodiments of the invention, digital safe deposit box module 108 may include notification engine 126 operable for generating notification based on occurrence of a safe deposit box event and initiating the communication of the notification to the designated notification party. As such, notification engine 126 may include user notification routine 152 operable to generate and communicate user notification based on the occurrence of a safe deposit box event. For example, a user may configure the notification routine 152 to generate and communicate a notification each time safe deposit box items are automatically uploaded from a third party or the safe deposit box provider, or each time certain designated safe deposit box items are uploaded from a third party. Additionally, the user may configure the notification routine to generate and communicate notifications when a safe deposit box item is approaching renewal or about to expire or, if the renewal had been designated by the user for automatic renewal, when the automatic renewal is pending or has occurred. The user of the safe deposit box may configure notification parameters, such as what events trigger a notification, how frequently notifications should be communicated, the communication mechanism used to communicate the notifications and the like. For example, communication mechanisms include, but are not limited to, email notifications, SMS notifications, voice mail notifications and the like.

In addition to the user notification routine 152, the notification engine 126 may include a third party notification routine 154 that is operable to notify designated third parties based on the occurrence of a safe deposit box event. For example, a third party notification may be generated and communicated to notify the third party of receipt of third party uploaded safe deposit box items or to notify the third party that a safe deposit box item distribution to the third party is occurring, has occurred, or is about to occur. Additionally, a user may designate a third party to be notified of safe deposit box events in lieu of and/or in addition to notification of the user. For example, a user may designate that an estate trustee be notified when certain estate related safe deposit box items are uploaded to the safe deposit box.

Thus, digital safe deposit box module 108 may additionally include renewal engine 124 operable to monitor safe deposit box items subject to renewal/expiration, such as insurance policies, warranties, automotive registration and the like, and notify the safe deposit box user of the need for renewal. Additionally, the renewal engine may provide for a link to the user/customer's banking account such that authorization by the user to renew an expiring safe deposit box item that requires a renewal payment may trigger automatic payment to the third party responsible for renewal. A renewed safe deposit box item may be delivered by the third party directly to the safe deposit box and automatically stored in the same category as the outdated safe deposit box item and the user may be notified of the arrival of the renewed safe deposit box item. Alternatively, if the user receives a hard-copy of the renewed document, the user may manually upload the document to the safe deposit box or provide the hard-copy of the document to the safe deposit box provider for their subsequent manual upload of the document to the user's safe deposit box. In certain optional embodiments, the renewal engine 124 may include automatic renewal routine 156 that is operable to provide for automatic renewal of safe deposit box items based on user designation of one or more renewable safe deposit box items as being designated for automatic renewal. As such, the automatic renewal routine may provide for identifying approaching deadlines for designated safe deposit box item renewal, automated payment of any renewal fee associated with the renewal and notification of the user once the renewal is initiated and/or the renewal payment is made and/or the renewed safe deposit box item has been received and stored in the safe deposit box 110.

The digital safe deposit box module 108 may also include a user configuration engine 136 operable to provide user configuration for one or more safe deposit box parameters. Configurable safe deposit box parameters may include, but are not limited to, automatic upload parameters 146, automatic distribution parameters 160, automatic renewal parameters 162, automatic notification parameters 164, and primary login parameters 163. Automatic upload parameters 146 may include, but are not limited to, the safe deposit box items to be automatically uploaded, the third party source of the uploaded items, the interval or time period for automatic uploads, the category/folder designated for the storage of the automatically uploaded safe deposit box items and the like. Automatic distribution parameters 160 may include, but are not limited to, safe deposit box items to be automatically distributed, the third party recipient of the distributed/communicated items, the interval or time period for automatic distribution, the category/folder location of the safe deposit box items to be distributed and the like. The automatic renewal parameters 162 may include, but are not limited to, the safe deposit box items that require renewal, the third party source for applying for renewal, the source for payment of renewal fees, notification requirements and the like. The automatic notification parameters 164 may include, but are not limited to, the events that trigger automatic notification, the party to be notified, the communication mechanism for the notification, the frequency of the notifications and the like. In one embodiment, the user configuration engine 136 may be operable to provide the user a primary login that is associated with an online banking portal. The primary login parameters 163 may include, but are not limited to, user login identifier (ID), user password, user security settings and the like.

The digital safe deposit box module 108 may also include a visibility configuration engine 137 operable to configure visibility parameters 165 for the digital safe deposit box 110. The visibility parameters 165 may include, but are not limited to, third party access settings, administration rights and the like. Administrative rights may include, but not be limited to, read access, write access, execute permissions, delete permissions and the like. In one embodiment, a third party may be granted access to view particular documents, but may not have the permission to edit such documents. Visibility parameters may be configured to restrict and/or grant third party access to view one or more safe deposit box items. In another embodiment, a third party may be granted access to view and edit a particular document in the user safe deposit box 110, but the access may be restricted such that the party may not view any other documents in the user safe deposit box 110, aside from the document for which access was granted. In another embodiment, a third party user may be assigned a secondary login, such that the secondary login may provide for limited administrative rights to access the user safe deposit box 110. In one embodiment, a third party may be granted one time access to the user safe deposit box 110. In another embodiment, a third party may be granted limited access to the user safe deposit box, such that access may be restricted to a specific amount of time, day of the week, month and the like. Third parties may include, but not be limited to business employees, vendors, physicians, tax consultants and the like. In one embodiment, visibility parameters may be configured for an associated user-configured digital safe deposit box category. In another embodiment, visibility parameters may be configured for each of the plurality of safe deposit box items.

Additionally, digital safe deposit box module 108 may include an authenticity engine 130 that is operable to provide an implicit seal of authenticity to safe deposit box items that have been uploaded. In this regard, the uploaded safe deposit box items are provided an automatic attestation as an original prior to storing the safe deposit box item in the digital safe deposit box 110. The authenticity engine 130 may be operable to authenticate a user 202 prior to granting access to the user digital safe deposit box 110. Means for authentication may include, but not be limited to credit/debit cards, password pins, digital certificates, RFID and the like. Further, digital safe deposit box module 108 may include a notarization engine 128 operable to provide a digital notarization for uploading safe deposit box items that require such.

Also, digital safe deposit box module 108 may include an encryption engine 132 operable to encrypt received uploaded safe deposit box items prior to storing the safe deposit box items in the digital safe deposit box 110 and operable to decrypt the safe deposit box items prior to user access of a document. In addition, the encryption engine 132 may be operable to provide encryption processing to third party distribution recipients and related key exchange to insure that distributed safe deposit box items are securely communicated across the communication network. Furthermore, the encryption engine 132 may be operable to create an encoded facsimile coversheet such that the user may print the encoded facsimile coversheet via the online banking portal 103. The facsimile coversheet sheet may be submitted with a plurality of safe deposit items being uploaded via facsimile. In one embodiment, the encryption engine 132 may position a barcode and/or QR code on the encoded facsimile coversheet such that the barcode and/or QR code may be used to link the safe deposit box item 144 to a specific safe deposit box category. For example, a device receiving the facsimile may read the barcode and/or QR located on the facsimile coversheet and automatically route the corresponding safe deposit box items 144 to the correct location within the safe deposit box 110. In one embodiment, the facsimile cover sheet may be general. For example, a general facsimile coversheet may indicate that a new document is being uploaded. In another embodiment, the facsimile coversheet may be document specific. For example, the document specific facsimile coversheet may indicate a new version of an existing safe deposit box item is being uploaded.

Digital safe deposit box module 108 may additionally include a search engine 134 that is operable to provide the safe deposit box user with ability to perform keyword searches as a means of locating items stored in the user's digital safe deposit box.

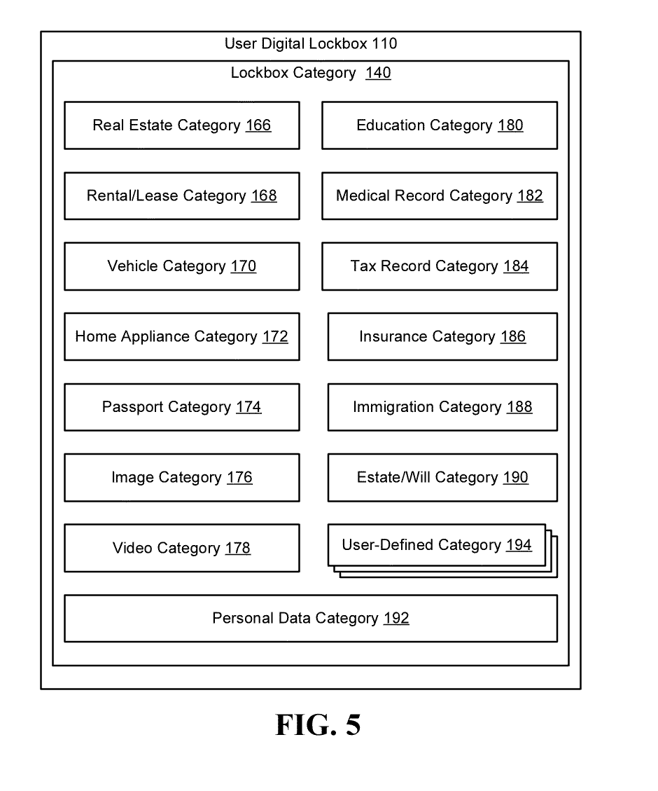

The memory 106 of apparatus 100 also stores the safe deposit box database 222. It should be noted that while safe deposit box database 222 is depicted and described as being stored in the memory 106 of apparatus 100 it may also be backed-up and stored within additional apparatus/devices to provide further security to the contents of the digital safe deposit boxes. Safe deposit box database 222 includes a plurality of safe deposit boxes 110, each safe deposit box associated with a user. In the context of financial institution provided safe deposit boxes, the users may be individual customers, small businesses or the like. Each user safe deposit box 110 includes a plurality of user-configured safe deposit box categories 140. In one embodiment of the invention, upon establishing the safe deposit box, the user may be presented with numerous pre-defined safe deposit box categories and the user may choose which pre-defined safe deposit box categories they desire to include in their safe deposit box. Additionally, the user may define their own specific safe deposit box categories as needed. Examples of safe deposit box categories are shown and described in relation to FIG. 5 infra. In addition, each safe deposit box category may include one or more category folders 142, which serve to provide for further cataloging of safe deposit box items 144. A user may select category folders 142 from pre-defined category folder choices or the user may define their own category folders 142. As shown in FIG. 3, safe deposit box items 144 may be cataloged and stored in category folders 142 or, in embodiments which do not implement category folders 142, the safe deposit box items may be cataloged and stored in safe deposit box categories 140.

In addition, to storing safe deposit box items 144, the digital safe deposit boxes 110 may also store user configuration data 138, such as user configured safe deposit box settings and configuration data related to automatic processing, such as automatic upload, automatic distribution, automatic renewal, automatic notification and the like.

Turning the reader's attention to FIG. 5, a block diagram is presented of exemplary safe deposit box categories which may be predefined for user selection or may be defined by the user for inclusion in user digital safe deposit box 110. Safe deposit box categories may include real estate category 166, lease category 168, vehicle category 170, home appliance category 172, passport category 174, image category 176, video category 178, education category 180, medical record category 182, tax record category 184, insurance category 186, immigration category 188, estate category 190, personal data category 192 and/or user-defined categories 194.

The real estate category 166 may include documents related to property mortgages, any deeds for property which the user owns, land survey plat maps and the like. Folders may be established within the real estate category 166 for different real estate properties that the user has an interest. The lease/rental category 168 may include documents related to property that the user is leasing/renting, such as rental agreements and the like. Additionally, lease/rental category 168 may include documents related to property that the user is the leasor/renter, such as rental agreements and the like. Folders may be established within the lease/rental category 168 for different properties that that the user may be currently or has in the past leased/rented.

The vehicle category 170 may include documents related to vehicles owned or leased by the user. The pertinent vehicles may include, but are not limited to, automobiles, motorcycles, bicycles, boats, airplanes and the like. The documents related to the vehicles may include sales/lease receipts, loan documents, titles, registration paperwork, vehicle license/tax documents and the like. Individual folders may be established in the vehicle category 170 for each individual vehicle that the user currently owns/leases or has owned/leased in the past. The home appliance category 172 may include documents related to home appliances such as warranties, user manuals or the like. Folders may be established in the home appliance category 172 for each of the relevant home appliances that the user currently possesses or has possessed in the past.

The passport category 174 may include documents related to passports, such as the passport itself and any application documentation related to applying for a passport. It should be noted that if the user is the head of a household, the passport category 174 may not only store the user's passport documentation but family member's passport documentation, as well. Thus, folders may be established in the passport category 174 for each individual family member or the like. The immigration category 188 may include documents related to the immigration status of the user, such Lawful Permanent Residence (LPR) documentation, citizenship paperwork or the like. Similar to the passport category, if the user is the head of a household, the immigration category 188 may not only store the user's immigration documentation but family member's immigration documentation, as well. Hence, folders may be established in the passport immigration category 188 for each individual family member or the like.

The education category 180 may include documents related to the user's and/or the user's family members education, such as diplomas, transcripts and the like. Folders may be established in the education category 180 for each school/institution attended and/or for each family member. The medical record category 182 may include documents related to the medical history of the user and/or the user's family members. Folders may be established in the medical record category 182 for each family member and/or for specific ailments, treatments, etc, or the like.

The tax record category 184 may include documents related to the user's income tax, property tax, vehicle tax and any other taxes associated with the user. In this regard, the tax record category 184 may store previous year income tax filing documentation. Additionally, tax record category 184 may store any sales receipts, credit card/debit card statements and the like that may be needed to prepare income tax filings and to establish proof of income tax filing specifics. Folders may be established in the tax record category 184 based on year and/or tax type.

Insurance category 186 may include documents related to the user's insurance policies, such as life insurance, medical insurance, vehicle insurance, home owner/renter insurance and the like. The documents stored in the insurance category may include the policy, benefactor information and the like. Thus, folders may be established in the insurance category 186 based on insurance type or the like. Estate category 190 may include any documents related to the user's estate, such as wills, trusts and the like or documents related to any estate that the user may have an interest.

Image category 176 and video category 178 may include digital images of any photograph, drawing or the like or video files. Safe deposit box storage of image or video files serves to preserve the file in digital form in the event that the original image or video is lost, stolen or otherwise destroyed.

Personal data category 192 allows the user to store personal data in the safe deposit box, such as passcodes, passwords, credit card numbers and contact numbers, such as credit card contact numbers in the event the credit card is lost or stolen. As previously noted, the digital safe deposit box of the present invention may be accessible through the Internet and may provide for platforms that provide for handheld wireless device accessibility. In this regard the data/information that is stored in the safe deposit box may be available to the user on-demand at any place or time. Thus, if a user forgets a passcode or a password, the user may access the digital safe deposit box to retrieve the passcode/password. In similar fashion, if the user loses or has stolen their credit card(s), they can access the personal data category of the digital safe deposit box to retrieve the contact information necessary to report the credit card as missing/stolen.

Additionally, as previously described, in addition to the other categories listed and described in relation to FIG. 5, the digital safe deposit box 110 may include other user-defined categories 194 based on the specific needs of the user. The user may define the categories 194 at the establishment of the safe deposit box 110 or the categories 194 may be established dynamically at any point in time after the safe deposit box has been established.

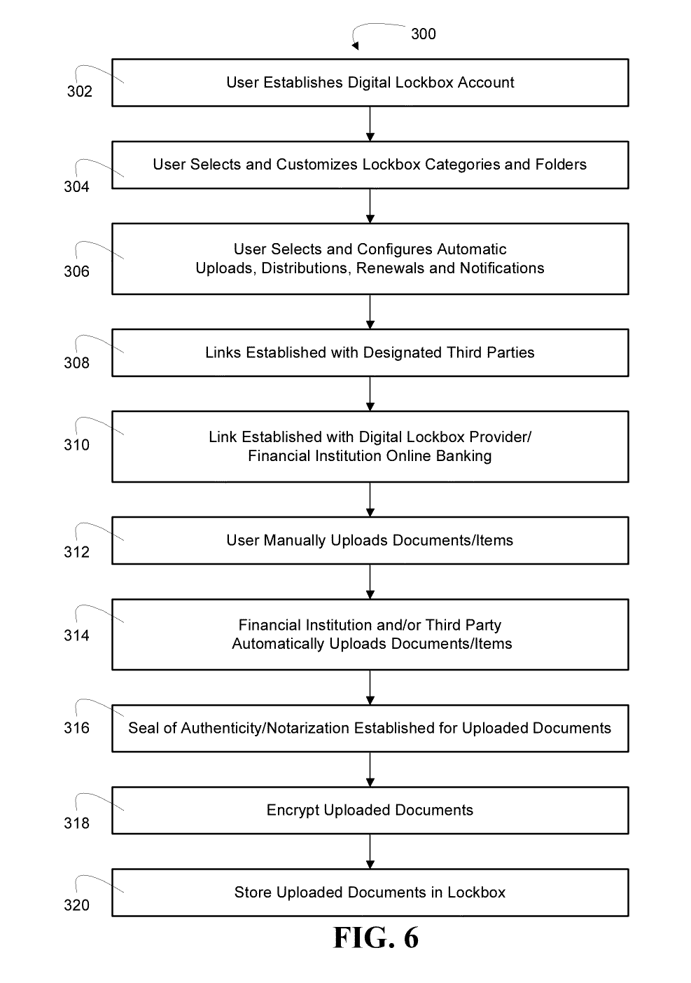

Referring to FIG. 6, a flow diagram is depicted of a method 300 for establishing a digital safe deposit box and uploading safe deposit box items to the safe deposit box, in accordance with embodiments of the present invention. At Event 302 the user establishes a digital safe deposit box account. In the embodiment in which the safe deposit box is provided for by a financial institution the safe deposit box may be offered to financial institution customers for a fee or an additional no-fee benefit to customers having certain account level balances. In addition, the financial institution or any other customer-based safe deposit box provider may offer the safe deposit box to non-customers if the provider so desires. According to embodiments in which the safe deposit box is provider by a financial institution the safe deposit box may be accessible through an online banking website or the like. Thus, the digital safe deposit box account may be established through a link provided for on the online banking website.

At Event 304, once the account has been established, the user selects and customizes safe deposit box categories and, optional folders within the categories. As previously discussed, the user may be presented with a listing of pre-defined categories that the user may desire and choose to include in their safe deposit box. The listing typically includes the most commonly implemented safe deposit box categories. In addition, the selection of safe deposit box categories may be logic-based, such that selection of one category may cause other related categories to be presented to the user for possible inclusion in their safe deposit box. In addition to the predefined categories that are selected by the user, the user may define their own categories and optional folders based on their specific needs.

At Event 306, the user may select and configure the parameters associated with automatic safe deposit box processing, such as automatic upload, automatic distribution, automatic renewal and automatic notification and the like. The parameters for automatic upload include, but are not limited to, identifying the safe deposit box items to be automatically uploaded, identifying the source of the automatic uploads, identifying the time period or intervals for the automatic uploads, identifying the category/folder designated for storage of the safe deposit box items and the like. The parameters for automatic distribution include, but are not limited to, identifying the safe deposit box items to be automatically distributed, identifying the recipients of the automatic uploads, identifying the time period or intervals for the automatic distributions, identifying the category/folder in the safe deposit box where the items to be distributed can be located and the like. The parameters for automatic renewal include, but are not limited to, identifying the safe deposit box items requiring renewal, identifying the third party entity associated with the renewal, identifying the renewal procedure, designating a source for renewal fees and defining user notification criteria related to the automated renewal. The parameters for automatic notification include, but are not limited to, the events that trigger notifications, the notification recipients, frequency of the notifications and the like. It should be noted that selection and configuration of automatic processing parameters may occur when the digital safe deposit box account is established or, dynamically, at any point in time after the account has been established.

At Event 308, links are established between the digital safe deposit box and the third parties designated for either automatic upload of safe deposit box items or distribution of safe deposit box items. At Event 310, links are established between the digital safe deposit box and the safe deposit box provider, such as a financial institution and, specifically, an online banking service provider by the financial institution. In this regard, recurring financial institution account information, such banking account statements, credit card statements, debit card statements, mortgage statements, loan statements and the like can be uploaded to the digital safe deposit box at predetermined intervals, such as monthly intervals or the like.

At Event 312, the user manually uploads safe deposit box items that it has in their possession. In certain embodiments, as previously discussed, the safe deposit box provider may provide for the user to physically deposit the safe deposit items in a depository and the safe deposit box provider may manually upload the documents to the user's safe deposit box. At Event 314, designated third party data sources and the safe deposit box provider, specifically a financial institution safe deposit box provider, upload safe deposit box items to the user's safe deposit box. The upload from the third party data sources and/or the safe deposit box provider may be based on a one-time-only request inputted by the user or the upload may be related to an automatic upload as defined by the user during the selection and configuration of automatic processing parameters, including automatic upload processing (Event 306).

At Event 316, the uploaded documents are authenticated and the safe deposit box provider, such as a financial institution provides an implicit seal of authenticity that serves as an automatic attestation that the uploaded document is an original. In addition, if the safe deposit box item requires notarization, an automated notarization process is provided for by the safe deposit box provider. At Event 318, the uploaded safe deposit box items are encrypted as a means of providing an additional level of security and protection to the contents of the digital safe deposit box. At Event 320, the safe deposit box items are stored in the user's digital safe deposit box.

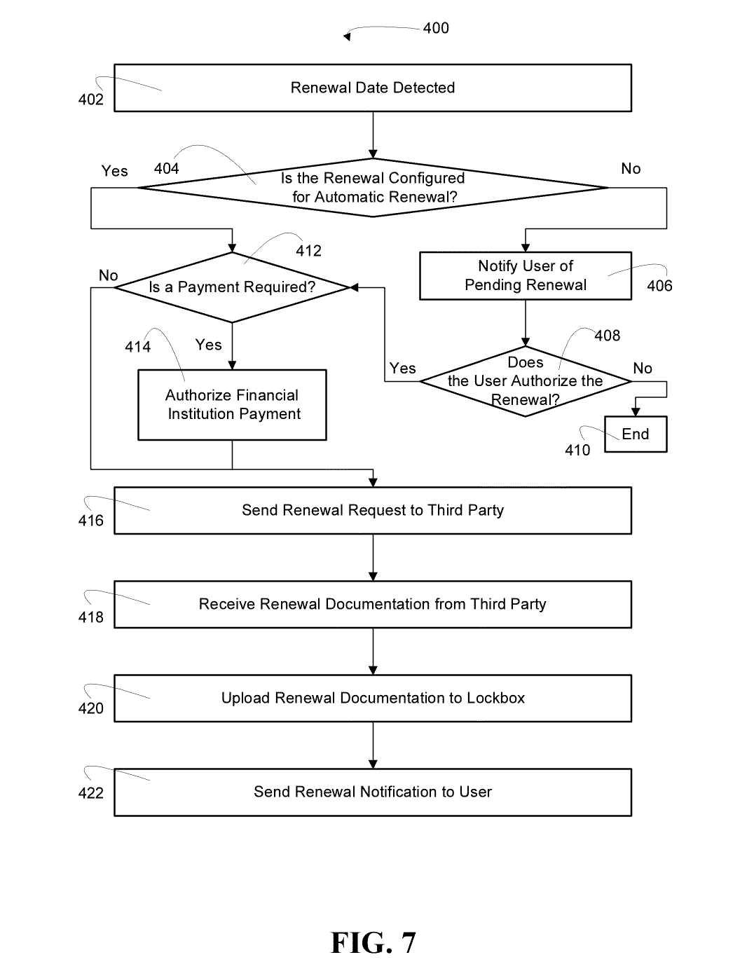

Referring to FIG. 7, a flow diagram is provided of a method 400 for implementing safe deposit box item renewal, in accordance with an embodiment of the present invention. As previously discussed certain safe deposit box items, such as insurance policies, warranties, vehicle registrations and the like may require continual renewal and the safe deposit box may be equipped with the capability to process the renewal. At Event 402, the safe deposit box determines that a renewal date is upcoming for a safe deposit box item. The safe deposit box item may have been previously identified by the user as an item requiring renewal and the date for renewal identified. In this regard a flag may be set that indicates a date prior to the actual renewal date, for example, thirty days prior to the renewal date. In other embodiments the third party renewal entity may issue a notification to the safe deposit box indicating that a renewal is pending. At Decision 404, a determination is made as to whether the renewal is configured for automatic renewal. Automatic renewal may be pre-configured by the user and provides for the renewal to occur without the need to receive authorization from the user. At Event 406, if the renewal is not configured for automatic renewal, the safe deposit box generates and communicates a notification to the safe deposit box user notifying the user of a pending renewal date.

At Decision 408, a determination is made as to whether the user authorizes the renewal. Authorization may be provided by the user accessing the digital safe deposit box and granting the safe deposit box the authority to proceed with the renewal or in some instances a response to the notification may trigger authorization of the renewal. If the user chooses to ignore the notification or provides an indication to the safe deposit box that the renewal is not authorized, at Event 410, the process is terminated. If the user grants authorization to pursue the renewal, by responding to the notification of accessing the safe deposit box and acquiescing to the renewal, at Decision 412 a determination is made as to whether the renewal requires payment of a renewal fee. In most instances, the renewal will incur a renewal fee and the safe deposit box may be configured to allow for automated payment of the renewal fee. Additionally, if the determination is made at Decision 404 that the renewal is configured for automatic renewal then, the process proceeds to Decision 412 for determination of whether a payment is required.

If a payment fee is required for, at Event 414, the safe deposit box notifies the financial institution and authorizes that a payment be made from a designated user bank account to the third party renewal entity. Once the payment has been authorized or if it is determined that no payment is required, at Event 416, the renewal request is sent to the third party renewal entity. For example, if the renewal is for vehicle registration the renewal request may be sent to the Department of Motor Vehicles (DMV) or the like or if the renewal is for home appliance warranty the renewal request may be sent to the home appliance manufacturer or the warranty-issuing entity or the like. At Event 416, the safe deposit box receives the renewal documentation, such an updated registration, warranty policy, insurance policy or the like, from the third party renewal entity.

At Event 418, the renewal documentation is stored in the safe deposit box. The renewal documentation may be stored in the same category and optional folder as the previous outdated safe deposit box item or the renewal documentation may prompt the user to designate a category/folder for storage of the renewal documentation. At Event 420, a notification may be sent to the user indicating that the renewal has been successfully processed and that renewal documentation has been received and stored in the safe deposit box.

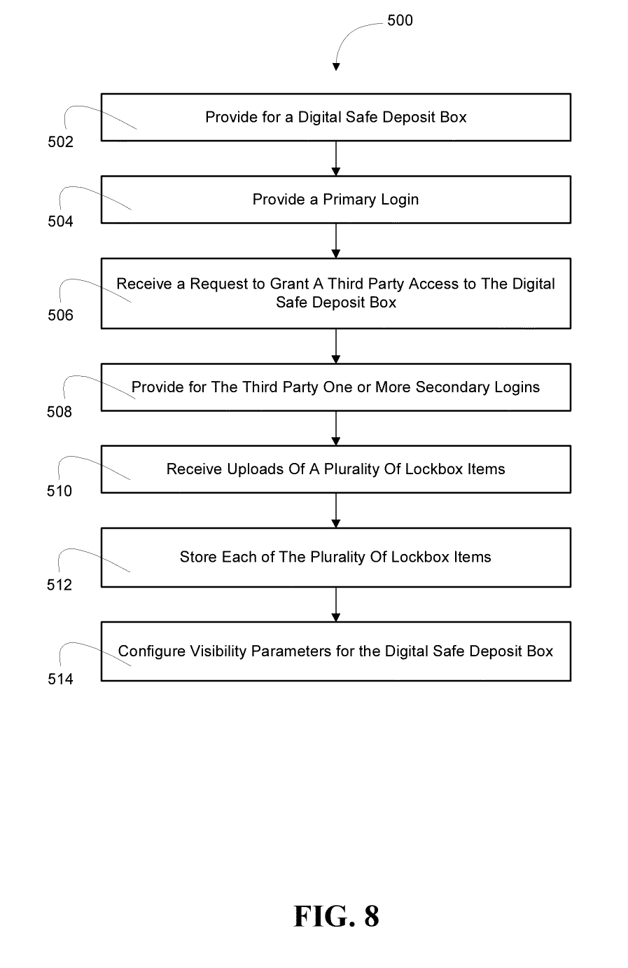

Referring now to FIG. 8 a method 500 is provided for digital safe deposit box storage in accordance with an embodiment of the present invention. At Event 502, a digital safe deposit box is provided that is associated with a user's online banking account such that the digital safe deposit box may be accessed via an online banking portal. In one embodiment, the digital safe deposit box includes one or more user-configured safe deposit box categories. As such, the user may select the safe deposit box categories from a listing of predefined safe deposit box categories or the user may define their own safe deposit box categories as needed. At Event 504, a primary login is provided. In one embodiment, the primary login may be associated with an online banking portal. As such, the user may be prompted to enter the primary login to authenticate their credentials prior to being able to access the digital safe deposit box.

At Event 506, a request is received from the user to grant a third party access to the digital safe deposit box. In one embodiment, a plurality of request may be received such that one or more third parties may be able to access the digital safe deposit box. In an alternative embodiment, a request may be received to revoke one or more third parties access to the digital safe deposit box. At Event 508, one or more secondary logins are provided. In one embodiment, the secondary login may be associated with a secondary login portal such that the digital safe deposit box may be accessed via the secondary login portal. As such, the third party may be prompted to enter the secondary login to authenticate their credentials prior to being able to access the digital safe deposit box.

At Event 510, uploads of a plurality of safe deposit box items are received. In accordance with specific embodiments of the invention, the uploads may be received from the user of the safe deposit box, a safe deposit box provider, such as a financial institution or a designated third party. The safe deposit box provider, such as a financial institution may be configured by the user to provide automatic and recurring uploads of safe deposit box items, such as financial institution account statements or the like. Additionally, the safe deposit box provider may provide for manual upload of hard-copy safe deposit box items that have been communicated to the provider from the user. Similarly, the user-designated third party may be configured to provide automatic and recurring uploads of safe deposit box items, for example, a credit card company may provide monthly uploads of a credit card statement or the like. Alternatively, the safe deposit box provider and/or third party uploads may be one-time-only uploads initiated at the bequest of the user.

At Event 512, the plurality of safe deposit box items are stored in an associated user-configured safe deposit box category. According to one embodiment of the invention the association between the safe deposit box items and the safe deposit box category may be determined based on user pre-configuration of the safe deposit box, such that predetermined safe deposit items are configured to be stored/cataloged in a predetermined associated safe deposit box category or safe deposit box items uploaded from a predetermined source, such as a predetermined third party source are configured to be stored/cataloged in a predetermined associated safe deposit box category. Alternatively, if the association between the safe deposit box item and the safe deposit box category is not determined based on user pre-configuration of the safe deposit box, the association may be determined based on metadata associated with the safe deposit box items, such that the digital safe deposit box may attempt to determine an appropriate associated storage category for the safe deposit box item based on metadata attributes.

At Event 514, the user may configure visibility parameters for the digital safe deposit box. In accordance with specific embodiments of the invention, configuring visibility parameters may comprise granting and/or restricting a third parties access to the digital safe deposit box. In one embodiment visibility parameters may be configured for an associated user-configured digital safe deposit box category. In another embodiment, visibility parameters may be configured for each of the plurality of safe deposit box items. In another embodiment, the user may have access to toggle the visibility of a safe deposit box item such that a third party may not be able to see it upon login to the digital safe deposit box.

Thus, methods, systems, computer program products and the like provide for a secure digital safe deposit box. The safe deposit box is all-encompassing, such that an individual can track and store all of their important documentation and other digital items in one comprehensive safe deposit box system. Ease of use is provided for by storing safe deposit box items in user-customizable categories and, in some embodiments, folders within the categories. The digital nature of the safe deposit box means that items stored therein are protected against physical damage due to fire, flood or the like and nefarious actions, such as theft, tampering or the like. Additionally, in those embodiments in which the safe deposit box is provided through a web-based platform, such as an online banking platform, and provided mobile device access through an applicable mobile device platform, the user is afforded on-demand and omnipresent access to the stored documentation and digital items.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for digital safe deposit box storage, the method comprising:
providing for a digital safe deposit box that is associated with a user's online banking account, wherein the digital safe deposit box is accessed by the user via an online banking portal;
providing for a primary login that is configured to allow the user to access the digital safe deposit box via the online banking portal;
receiving, from the user, a request to grant a third party access to the digital safe deposit box;
providing, a secondary login to the third party based at least partially on the request, wherein the secondary login is configured to allow the third party access to the digital safe deposit box via a secondary login portal;
receiving, at a computing device, uploads of a plurality of safe deposit box items;
storing each of the plurality of safe deposit box items in the digital safe deposit box; and
providing the third party access to one or more safe deposit box items based on the user preconfiguring visibility settings for the one or more safe deposit box items to allow for the third party entity to access the one or more safe deposit box items.

2. The method of claim 1, wherein receiving uploads of the plurality of safe deposit box items further comprises receiving at least one uploads of a safe deposit box item having a duplicate filename of an existing safe deposit box item, wherein the safe deposit box item is uploaded as a new version of the existing safe deposit box item.

3. The method of claim 1, wherein receiving uploads of the plurality of safe deposit box items further comprises providing for a facsimile gateway such that the plurality of safe deposit items are uploaded via facsimile.

4. The method of claim 3, wherein providing for a facsimile gateway further comprises creating an encoded facsimile coversheet such that the user is able to print the encoded coversheet via the online banking portal, wherein the encoded facsimile coversheet is submitted with the plurality of safe deposit items being uploaded via facsimile.

5. The method of claim 4, wherein creating an encoded facsimile coversheet further comprises creating a general encoded facsimile coversheet such that the general encoded facsimile coversheet specifies a new safe deposit box item is being uploaded.

6. The method of claim 4, wherein creating an encoded facsimile coversheet further comprises creating a document-specific encoded facsimile coversheet such that the document specific facsimile coversheet specifies a new version of an existing safe deposit box item is being uploaded.

7. The method of claim 4, wherein creating an encoded facsimile coversheet further comprises distributing the encoded facsimile coversheet to the third party.

8. The method of claim 1, wherein receiving uploads of the plurality of safe deposit box items further comprises receiving uploads of the plurality of safe deposit box items via an authenticated kiosk such that the plurality of safe deposit box items are scanned at the authenticated kiosk, wherein the authenticated kiosk is located at a banking branch.

9. The method of claim 1, wherein receiving uploads of the plurality of safe deposit box items further comprises receiving uploads of the plurality of safe deposit box items via an enhanced ATM, wherein the enhanced ATM has scanning capabilities such that the plurality of safe deposit box items are scanned at the enhanced ATM.

10. The method of claim 1, wherein storing each of the plurality of safe deposit box items further comprises storing a plurality of notes such that the notes provide comments for one or more safe deposit box items.

11. The method of claim 1, wherein providing for a digital safe deposit box further comprises providing for the digital safe deposit box having one or more user-configured safe deposit box categories.

12. The method of claim 11, wherein providing the third party access to one or more safe deposit box items further comprises providing the third party access to one or more of the safe deposit box categories based on the user preconfiguring visibility settings for the one or more safe deposit box items to allow for the third party entity to access the one or more safe deposit box items.

13. An apparatus for digital safe deposit box storage, the apparatus comprising:
a computer processing device;
a memory;
a digital safe deposit box database stored in the memory and including a plurality of user digital safe deposit boxes, each having one or more user-configured digital safe deposit box categories; and
a digital safe deposit box module stored in the memory and executable by the computer processing device, wherein the digital safe deposit box module comprises:
a user configuration engine operable to provide a user a primary login that is configured to allow the user access to their corresponding digital safe deposit box;
an external third party integration engine operable to receive a request from the user to grant a third party access to their digital safe deposit box, and provide the third party a secondary login, based at least partially on the request, wherein the secondary login is configured to allow the third party access to the user's digital safe deposit box;
an item upload engine operable to receive uploads of a plurality of safe deposit box items and store the plurality of safe deposit box items in a designated safe deposit box category of a designated user safe deposit box; and
a safe deposit box visibility configuration engine operable to allow the user to configure visibility parameters for the digital safe deposit box, such that the third party has access to only those items or categories to which they have been granted access.

14. The apparatus of claim 13, wherein the item upload engine is further operable to receive uploads of a safe deposit box item having a duplicate filename of an existing safe deposit box item, wherein the safe deposit box item is uploaded as a new version of the existing safe deposit box item.

15. The apparatus of claim 13, wherein the item upload engine is further operable to provide a facsimile gateway such that the plurality of safe deposit items are uploaded via facsimile.

16. The apparatus of claim 15, wherein the apparatus further comprises an encryption engine operable to operable to create an encoded facsimile coversheet such that the user is able to print the encoded coversheet via the online banking portal, wherein the encoded facsimile coversheet is submitted with the plurality of safe deposit items being uploaded via facsimile.

17. The apparatus of claim 16, wherein the encryption engine is further operable to create a general encoded facsimile coversheet such that the general encoded facsimile coversheet specifies a new safe deposit box item is being uploaded.

18. The apparatus of claim 16, wherein the encryption engine is further operable to create a document-specific encoded facsimile coversheet such that the document specific facsimile coversheet specifies a new version of an existing safe deposit box item is being uploaded.

19. The apparatus of claim 16, wherein the apparatus further comprises an item distribution engine operable to distribute the encoded facsimile coversheet to the third party.

20. The apparatus of claim 13, wherein the item upload engine is further operable to receive uploads of the plurality of safe deposit box items via an authenticated kiosk such that the plurality of safe deposit box items are scanned at the authenticated kiosk, wherein the authenticated kiosk is located at a banking branch.

21. The apparatus of claim 13, wherein the item upload engine is further operable to receive uploads of the plurality of safe deposit box items via an enhanced ATM, wherein the enhanced ATM has scanning capabilities such that the plurality of safe deposit box items are scanned at the enhanced ATM.

22. The apparatus of claim 13, wherein the item upload engine is further operable to store a plurality of notes such that the notes provide comments for one or more safe deposit box items.

23. The apparatus of claim 13, wherein visibility parameters are configured for an associated user-configured digital safe deposit box category.

24. The apparatus of claim 13, wherein visibility parameters are configured for each of the plurality of safe deposit box items.

25. A computer program product comprising:
a non-transitory computer-readable medium comprising:
a first set of codes for causing a computer to provide for a digital safe deposit box that is associated with a user's online banking account, wherein the digital safe deposit box is accessed by the user via an online banking portal;
a second set of codes for causing a computer to provide for a primary login that is configured to allow the user to access the digital safe deposit box via the online banking portal;
a third set of codes for causing a computer to receive, from the user, a request to grant a third party access to the digital safe deposit box;
a fourth set of codes for causing a computer to provide a secondary login to the third party, based at least partially on the request, wherein the secondary login is configured to allow the third party access to the digital safe deposit box via a secondary login portal;
a fifth set of codes for causing a computer to receive uploads of a plurality of safe deposit box items;
a sixth set of codes for causing a computer to store each of the plurality of safe deposit box in the digital safe deposit box; and
a seventh set of codes for causing a computer to provide the third party access to one or more safe deposit box items based on the user preconfiguring visibility settings for the one or more safe deposit box items to allow for the third party to access the one or more safe deposit box items.

26. The computer program product of claim 25, wherein the fifth set of codes further comprises the fifth set of codes for causing a computer to receive at least one upload of a safe deposit box item having a duplicate filename of an existing safe deposit box item, wherein the safe deposit box item is uploaded as a new version of the existing safe deposit box item.

27. The computer program product of claim 25, further comprising an eighth set of codes for causing a computer to provide a facsimile gateway such that the plurality of safe deposit items are uploaded via facsimile.

28. The computer program product of claim 27, further comprising a ninth set of codes for causing a computer to create an encoded facsimile coversheet such that the user is able to print the encoded coversheet via the online banking portal, wherein the encoded facsimile coversheet is submitted with the plurality of safe deposit items being uploaded via facsimile.

29. The computer program product of claim 28, wherein the ninth set of codes further comprises the ninth set of codes for causing a computer to create a general encoded facsimile coversheet such that the general encoded facsimile coversheet specifies a new safe deposit box item is being uploaded.

30. The computer program product of claim 28, wherein the ninth set of codes further comprises the ninth set of codes for causing a computer to create a document-specific encoded facsimile coversheet such that the document specific facsimile coversheet specifies a new version of an existing safe deposit box item is being uploaded.
